(19) United States
(12) Patent Application Publication
(10) Pub. No.: US 2025/0163982 A1
(43) Pub. Date: May 22, 2025

(54) BRAKE APPARATUS AND CONTROL METHOD THEREOF

(71) Applicant: HL MANDO CORPORATION, Pyeongtaek-si (KR)

(72) Inventor: Jaehyun PARK, Pyeongtaek-si (KR)

(21) Appl. No.: 18/677,145

(22) Filed: May 29, 2024

(30) Foreign Application Priority Data
Nov. 21, 2023 (KR) 10-2023-0162613

(51) Int. Cl. F16D 65/38; B60T 17/22; F16D 51/20; F16D 65/22; F16D 66/00; F16D 121/24

(52) U.S. Cl. CPC F16D 65/38; B60T 17/22; F16D 51/20; F16D 65/22; F16D 66/00; F16D 2065/386; F16D 2066/003; F16D 2066/005; F16D 2066/006; F16D 2121/24

(57) ABSTRACT

Disclosed herein is a brake apparatus that may include a rotating member, a friction member that applies a frictional force to the rotating member, a motor that moves the friction member, and a controller that controls operation of the motor. The controller may determine a reference position based on a position of the friction member at a time point at which the friction member is no more in contact with the rotating member when the brake is released and control movement of the friction member from the reference position to adjust a distance between the friction member and the rotating member based on an estimated temperature of the rotating member when the brake is released.

### CROSS-REFERENCE TO RELATED APPLICATION

This application claims the benefit of Korean Patent Application No. 10-2023-0162613, filed on Nov. 21, 2023 in the Korean Intellectual Property Office, the disclosure of which is incorporated herein by reference.

### BACKGROUND

### 1. Field

Embodiments of the present disclosure relate to a brake apparatus, and more specifically, to a brake apparatus and a control method thereof, which allow a brake to be controlled after estimating a temperature of the brake so as to prevent brake drag.

### 2. Description of the Related Art

Electro-mechanical brakes (EMBs) refer to electronic brake apparatuses that generate a brake force by generating a clamping force through a motor and mechanism, instead of using hydraulic pressure to generate a brake force as in existing brake apparatuses.

The brake apparatuses may be deformed due to thermal deformation depending on the temperature. In electric drum brakes, when the temperature drops after engaging at a high temperature, a phenomenon in which the clamping force increases due to thermal deformation, i.e., contraction of the drum, occurs. When the electric drum brake is disengaged before the temperature has not dropped sufficiently, the clamping force may not be reduced sufficiently, which may cause brake drag.

### SUMMARY

Therefore, it is an aspect of the present disclosure to provide a brake apparatus and a control method thereof, which allow a brake to be controlled after estimating a temperature of the brake so as to prevent brake drag.

In accordance with one aspect of the present disclosure, a brake apparatus includes a rotating member, a friction member that applies a frictional force to the rotating member, a motor that moves the friction member, and a controller that controls operation of the motor, wherein the controller determines a reference position based on a position of the friction member at a time point at which the friction member is no more in contact with the rotating member upon brake release and control movement of the friction member from the reference position to adjust a distance between the friction member and the rotating member based on an estimated temperature of the rotating member upon brake release.

The brake apparatus may further include a force sensor that detects a clamping force of the friction member.

The controller may determine, based on a current applied to the motor and the clamping force detected by the force sensor, a position of the friction member at the time point at which the friction member is no more in contact with the rotating member upon brake release to be the reference position.

The controller may determine, based on a current applied to the motor and position information of the motor, a position of the friction member at the time point at which the friction member is no more in contact with the rotating member upon brake release to be the reference position.

The friction member may include a brake lining.

The rotating member may include a drum.

The controller may further move the friction member to a predetermined reference distance from the reference position when the estimated temperature of the rotating member is less than or equal to a predetermined reference temperature.

Based on the estimated temperature of the rotating member being higher than a predetermined reference temperature, the controller may move the friction member to a predetermined reference distance plus an additional distance determined based on the estimated temperature of the rotating member from the reference position.

The reference distance may range from 0.3 mm to 0.8 mm.

The controller may estimate a temperature of the rotating member based on a brake force of the brake.

Based on the temperature of the rotating member being not estimated, the controller may move the friction member to a distance equal to a predetermined reference distance plus a predetermined maximum additional distance from the reference position.

In accordance with another aspect of the present disclosure, a method of controlling a brake apparatus including a rotating member, a friction member that applies a frictional force to the rotating member, and a motor that transmits mechanical energy to the friction member, which includes determining a reference position based on a position of the friction member at a time point at which the friction member is no more in contact with the rotating member upon brake release of the brake apparatus is released, and controlling movement of the friction member from the reference position to adjust a distance between the friction member and the rotating member based on an estimated temperature of the rotating member upon brake release of the brake apparatus.

The method may further include detecting a clamping force of the friction member.

The determining of the reference position may include determining, based on a current applied to the motor and the clamping force of the friction member, a position of the friction member at the time point at which the friction member is no more in contact with the rotating member upon brake release to be the reference position.

The determining of the reference position may include determining, based on a current applied to the motor and position information of the motor, a position of the friction member at the time point at which the friction member is no more in contact with the rotating member upon brake release to be the reference position.

The controlling of the movement of the friction member may include further moving the friction member to a predetermined reference distance from the reference position when the estimated temperature of the rotating member is less than or equal to a predetermined reference temperature.

The controlling of the movement of the friction member may include, Based on the estimated temperature of the rotating member being higher than a predetermined reference temperature, moving the friction member to a distance equal to a predetermined reference distance plus an additional distance determined based on the estimated temperature of the rotating member from the reference position.

The reference distance may range from 0.3 mm to 0.8 mm.

The method may further include estimating a temperature of the rotating member based on a brake force of the brake.

The method may further include moving, based on the temperature of the rotating member being not estimated, the friction member to a distance equal to a predetermined reference distance plus a predetermined maximum additional distance from the reference position.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a brake apparatus according to one embodiment of the present disclosure;

FIG. 2 is a block diagram of a brake apparatus according to one embodiment of the present disclosure;

FIG. 3 is a graph illustrating an estimated temperature of a brake apparatus according to one embodiment of the present disclosure;

FIG. 4 is a graph illustrating changes in a clamping force and a position of a friction member over time in a brake apparatus according to one embodiment of the present disclosure;

FIG. 5 is a graph illustrating an estimated temperature of a brake apparatus according to one embodiment of the present disclosure;

FIG. 6 is a graph illustrating changes in a clamping force and a position of a friction member over time in a brake apparatus according to one embodiment of the present disclosure;

FIG. 7 is a graph illustrating changes in position of a friction member depending on an estimated temperature of a brake apparatus according to one embodiment of the present disclosure; and

FIG. 8 is a flowchart illustrating a brake apparatus control method according to one embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

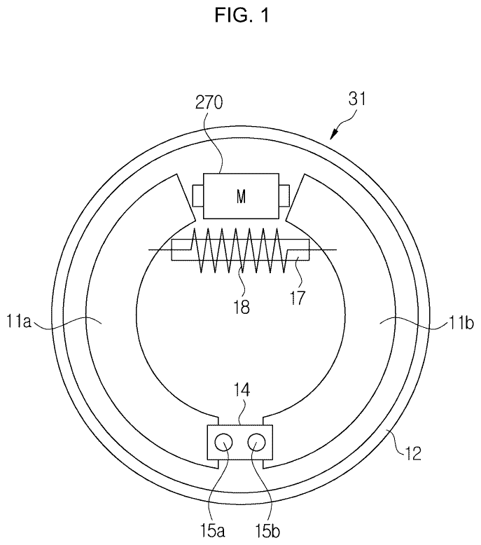

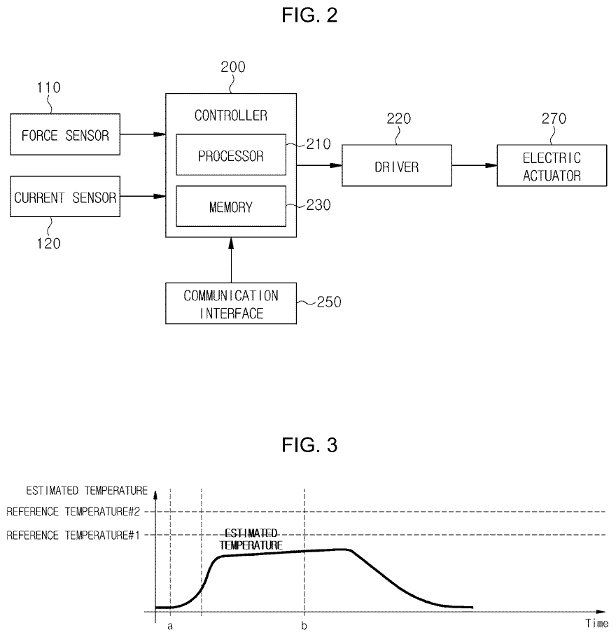

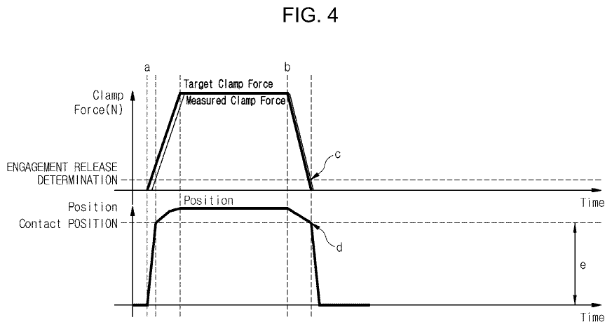

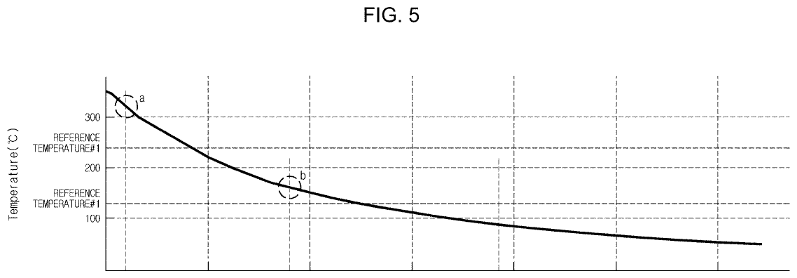

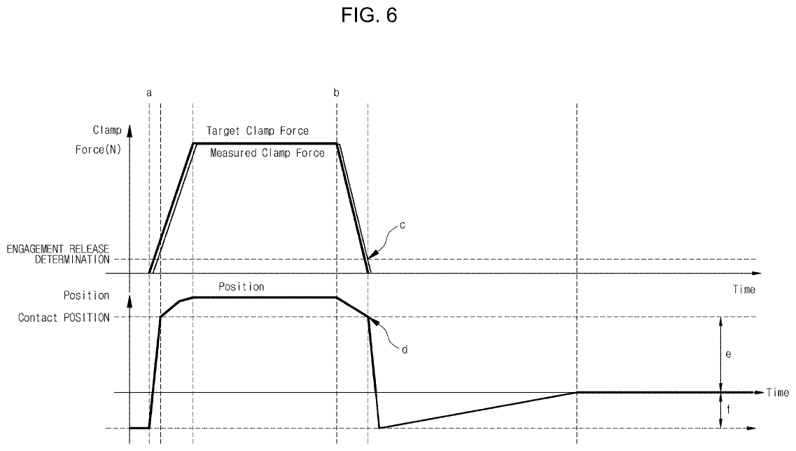

FIG. 1 is a view illustrating a drum brake of a brake apparatus according to one embodiment. FIG. 2 is a block diagram of a brake apparatus according to one embodiment of the present disclosure. FIG. 3 is a graph illustrating an estimated temperature of a brake apparatus according to one embodiment of the present disclosure. FIG. 4 is a graph illustrating changes in a clamping force and a position of a friction member over time in a brake apparatus according to one embodiment of the present disclosure. FIG. 5 is a graph illustrating an estimated temperature of a brake apparatus according to one embodiment. FIG. 6 is a graph illustrating changes in a clamping force and a position of a friction member over time in a brake apparatus according to one embodiment of the present disclosure.

A brake apparatus 30 stops a vehicle, and for example, a drum-type brake may include a drum 12 as a rotating member and a brake lining as a friction member that applies frictional force to the rotating member. The drum-type brake may include an electronic brake control module (EBCM). The brake lining may decelerate the vehicle or stop the vehicle using friction with the drum 12, and the electronic brake control module may control the brake lining in response to the driver's intention to brake via a brake pedal and/or a request from a driving assistance device 100. For example, the electronic brake control module may receive a deceleration request including a deceleration rate from the driving assistance device 100 and may control the brake lining electrically or by hydraulic pressure so that the vehicle is decelerated according to the requested deceleration rate, but the electronic brake apparatus according to the embodiment of the present disclosure may control the brake lining electrically.

Meanwhile, the brake apparatus 30 may be deformed due to thermal deformation depending on the temperature. In the electric drum brake, when the temperature drops after engaging at a high temperature, a phenomenon in which an engagement force increases due to thermal deformation, i.e., contraction of the drum, occurs. When the electric drum brake is disengaged before the temperature has not dropped sufficiently, the engagement force may not be reduced sufficiently, which may cause the brake to drag.

In the case of existing drum brakes, a separate mechanism (thermo-clip or auto-adjuster) may be used to address the above problem by controlling a distance between the brake lining and the drum (Total Shoe Center Clearance (TSCC)). However, because these components are hardware components, the components may be less accurate and may cause deviations in the brake response between the left and right drum brakes, which can reduce vehicle stability.

Accordingly, the brake apparatus 30 according to the embodiment of the present disclosure may estimate the temperature of the rotating member, i.e., the drum 12, and adjust a distance between the friction member, i.e., the brake lining, and the drum 12, so as to prevent unintended vehicle movements due to brake drag.

The brake apparatus 30 according to the embodiment of the present disclosure may employ a drum brake, and the type of brake is not limited. Hereinafter, an example of the brake apparatus 30 according to the embodiment of the present disclosure will be described using a drum-type brake apparatus.

Referring to FIG. 1, a drum brake 31 has a structure in which a pair of brake shoes 11a and 11b provided in a drum 12 and to which brake linings are attached expand and brake the drum 12 rotating together with a wheel. Generally, the drum brake 31 is often mounted on the rear wheels of a vehicle.

The drum brake 31 may include the pair of brake shoes 11a and 11b in an arc shape installed to be movable along a surface of a backing plate coupled to a vehicle body, a drum 12 having a friction surface on the inner circumferential side and rotating together with the wheel, and an electric actuator 270 that applies a force to each of the brake shoes 11a and 11b in the direction of expanding the pair of brake shoes 11a and 11b.

The pair of brake shoes 11a and 11b are connected to the electric actuator 270 installed on the backing plate at one ends facing each other. The pair of brake shoes 11a and 11b have one side connected to the electric actuator 270 and the other side, which is opposite to the one side, connected to pins 15a and 15b of an anchor member 14 fixed to the backing plate. As a result, the brake shoes 11a and 11b do not rotate along with the drum 12.

A strut 17 and a spring 18 are provided between the pair of brake shoes 11a and 11b. The strut 17 serves as an adjuster to adjust a gap between the friction surfaces between the pair of brake linings and the drum 12 according to the wear of the brake linings. In addition, the brake shoes 11a and 11b are fixed one-to-one to both ends of the spring 18 so that the pair of brake shoes 11a and 11b are arranged close to each other.

The electric actuator 270 has an electric motor M, a reducer, and a pressing mechanism including a ball screw mechanism. When the electric motor M rotates in one direction, its output shaft rotates, and at the same time, the number of rotations is decreased by the reducer. Then, this rotational motion is converted into linear motion by the ball screw mechanism, and the pair of brake shoes 11a and 11b are each pressed in a direction away from each other. Accordingly, the pair of brake shoes 11a and 11b to which brake linings are attached press the drum 12 to generate a brake force. On the other hand, when the electric motor M rotates in a reverse direction, the pair of brake shoes 11a and 11b to which the brake linings are attached that are pressing the drum 12 are separated from the drum 12 so that the brake force is released.

Referring to FIG. 2, the brake apparatus 30 may include a controller 200 that controls the operation of the drum brake 31 provided on at least one of the wheels, a driver 220 that drives the electric actuator 270 of the drum brake 31 in response to a control signal of the controller 200, a current sensor 120 that detects a current supplied to the electric motor M of the electric actuator 270, a communication interface 250 capable of transmitting and receiving communication signals with various systems installed in a vehicle through a vehicle communication network, and a force sensor 110 capable of detecting a clamping force of a brake lining, which is a friction member, on the drum 12, which is a rotating member.

The controller 200 may include a processor 210 and a memory 230.

The controller 200 may perform a braking operation mode for engaging the drum brake 31 or a brake release mode for disengaging the drum brake 31 according to a manipulation signal generated in response to the driver's brake manipulation. In the braking operation mode, the controller 200 may perform a braking operation (braking apply) to generate a clamping force required for braking by the pair of brake shoes 11a and 11b pressing the drum 12 using the electric actuator 270 of the drum brake 31.

In the brake release mode, the controller 200 may perform a braking release operation (braking release) in which the generated clamping force is released by releasing the pair of brake shoes 11a and 11b in close contact with the drum 12 from the drum 12 using the electric actuator 270 of the drum brake 31.

In the braking operation mode, the controller 200 rotates the electric motor M in one direction until a current value of the electric motor M of the electric actuator 270 reaches a target current value corresponding to the clamping force required for braking. Meanwhile, in the brake release mode, the controller 200 rotates the electric motor M in the reverse direction until the current of the electric motor M reaches a target current value corresponding to braking release.

The driver 220 may rotate the electric motor M in the forward or reverse direction in response to a control signal from the controller 200. For example, the driver 220 may include an H-bridge circuit including a plurality of power switching elements for rotating the electric motor M in the forward or reverse direction. During the braking operation in which the electric motor M is rotated in one direction by the driver 220, the number of one-directional rotations of the electric motor M is decreased through the reducer, the ball screw mechanism is moved in a straight line with a large force so that the pair of brake shoes 11a and 11b to which brake linings are attached may press the drum 12 to brake the wheels. The braking release operation may operate in reverse to the braking operation.

The controller 200 may receive the current of the electric motor M detected by the current sensor 120 and the clamping force detected by the force sensor 110. Based on the current detected by the current sensor 120 and the clamping force detected by the force sensor 110, the controller 200 may determine a reference position, which is a position of the friction member at a time point at which the brake lining which is the friction member is no more in contact with the drum 12 which is the rotating member, when the brake is released. A detailed description thereof will be provided later.

The controller 200 may receive various types of vehicle state information, such as brake pedal status information, gear shift information, wheel speed information, and brake pressure information, from various systems through the communication interface 250.

The controller 200 may determine a braking operation request for engaging the drum brake 31 or a braking release request for disengaging the drum brake 31 based on information input via the communication interface 250.

As described above, in the case of the drum brake 31, when the drum brake 31 is engaged at a high temperature and then the temperature drops, a phenomenon in which an engagement force increases due to thermal contraction of the thermally expanded drum 12 occurs. When the drum brake 31 is disengaged while the temperature has not sufficiently dropped, brake drag may occur due to the thermal contraction of the drum 12.

In determining a distance between the friction member and the rotating member when the brake is released, the brake apparatus 30 according to the embodiment of the present disclosure may prevent drag by estimating the temperature of the drum 12, which is a rotating member, and determining the distance between the friction member and the rotating member based on the estimated temperature.

When a braking request is received due to the driver's manipulation or the like while the vehicle is traveling, the controller 200 of the brake apparatus 30 controls the actuator 270 to generate the brake force as described above. When the brake force is generated and then braking release becomes necessary due to no breaking request, the controller 200 similarly controls the actuator 270 to release the brake by disengaging the brake lining, which is a friction member, from the drum 12 which is a rotating member.

FIGS. 3 and 4 show a case where an estimated temperature of the rotating member is lower than a predetermined reference temperature. Here, the reference temperature may include two reference temperatures, as shown in FIG. 3, and a case where the estimated temperature is lower than the predetermined reference temperature refers to a case where the estimated temperature of the friction member is lower than the lower temperature of the two reference temperatures at a brake force release time point b.

The controller 200 may estimate a temperature of the rotating member, i.e., the drum 12, from various types of information input via the communication interface 250. The controller 200 may estimate the temperature of the drum 12 from wheel speed information and brake pressure information input via the communication interface 250.

For example, when a driver steps on a brake pedal to reduce speed while driving a vehicle, the brake shoes 11a and 11b, to which the brake linings are attached, press the drum 12. When frictional force occurs due to the drum 12 and the brake lining in contact with each other, the kinetic energy of the vehicle is converted into frictional energy between the drum 12 and the brake lining. The friction energy is converted into heat energy, and some of the heat energy escapes into the air and some of the heat energy are absorbed by the drum 12. Among them, the heat energy absorbed by the drum 12 increases the temperature of the drum 12.

Conversely, while the vehicle is traveling or stationary without braking, the heat energy absorbed by the drum 12 escapes to the surrounding connected parts or to the atmosphere in the form of conduction, convection, or radiation, causing the temperature to decrease. Using this conversion process of heat energy, a mathematical model may be created to calculate the temperature of the drum 12.

The frictional energy generated by the frictional force is converted into heat energy and absorbed by the drum 12. The heat energy generated by a frictional force may be expressed as a function of the friction coefficient of the brake lining, brake pressure, wheel speed, etc. When the vehicle is traveling or stationary without braking, the heat energy absorbed by the drum 12 is transferred to the surrounding atmosphere or connected parts in the form of conduction, convection, radiation, etc.

The total amount of heat energy dissipated from the drum 12 in the form of conduction, convection, and radiation may be calculated by adding all of the respective heat energies. The heat energy dissipated by the vehicle speed may be expressed as a function of wheel speed, air temperature, etc.

The final temperature of the drum 12 is determined by a difference between the heat energy absorbed by the drum 12 and the heat energy transferred to the outside during a certain time. From an amount of temperature change due to the difference between the two heat energies, the current temperature of the drum 12 may be obtained. While the vehicle is traveling, the temperature of the drum 12 may be continuously calculated. In addition, the controller 200 may directly detect the temperature of the drum 12 through a temperature sensor that detects the temperature of the drum 12.

When the estimated temperature of the rotating member in the controller 200 is lower than a predetermined reference temperature, the controller 200 may determine a distance between the friction member and the rotating member by adding a predetermined reference distance e to the reference position d, which is the position of the friction member at an engagement release time point c at which the friction member is no more in contact with the rotating member after the brake force release time point b. Here, the reference distance e may have a value ranging from 0.3 mm to 0.8 mm.

More specifically, referring to FIG. 4, from a brake force request time point a by the driver's brake pedal operation, the controller 200 controls the friction member's clamping force on the rotating member to increase while following the target clamping force, thereby maintaining the target clamping force.

From a time point b at which a brake force release request is input by the driver's brake pedal operation, the controller 200 controls the clamping force to decrease while following the target clamping force, and when the clamping force reaches a predetermined reference clamping force, determines the corresponding time point to be an engagement release time point c at which the friction member is no more in contact with the rotating member.

Additionally, the controller 200 determines the position of the friction member at the engagement release time point to be the reference position d. The controller 200 may use this reference position d as a zero point to determine the distance added by the predetermined reference distance e as the distance between the friction member and the rotating member to separate the friction member from the rotating member by the reference distance e.

That is, as shown in FIG. 3, when the estimated temperature of the drum 12 is lower than the predetermined reference temperature, the controller 200 separates the friction member from the rotating member by the reference distance e from the reference position d where the friction member is no more in contact with the rotating member when the brake is released, as shown in FIG. 4.

FIGS. 5 and 6 show a case where an estimated temperature of the drum 12 is higher than a predetermined reference temperature. Here, the reference temperature may include two reference temperatures, as shown in FIG. 5, and a case where the estimated temperature is higher than the predetermined reference temperature refers to a case where the estimated temperature of the friction member is higher than the lower temperature of the two reference temperatures at a brake force release time point b.

When the estimated temperature of the rotating member estimated by the controller 200 is higher than the predetermined reference temperature, the controller 200 may determine the distance between the friction member and the rotating member by adding a predetermined reference distance e to the reference position d, which is the position of the friction member at an engagement release time point c at which the friction member is no more in contact with the rotating member after the brake force release time point b, and further adding an additional distance f thereto. Here, the reference distance e may have a value ranging from 0.3 mm to 0.8 mm.

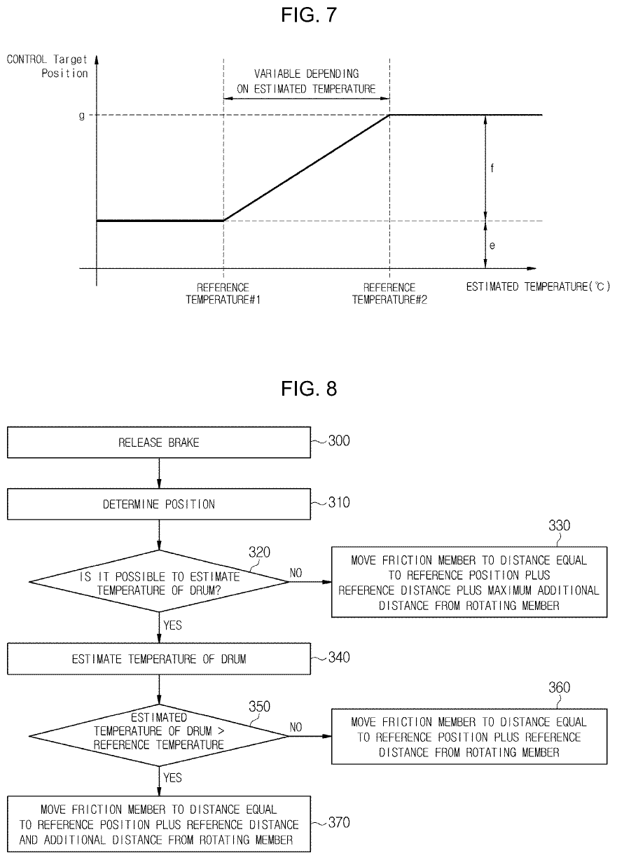

The additional distance f is a value that may vary depending on the estimated temperature when the estimated temperature is higher than the reference temperature and a value that increases as the estimated temperature is increasingly higher than the reference temperature, as shown in FIG. 7. That is, when the estimated temperature of the drum 12 is higher than the reference temperature at the brake force release time point, the drum 12 may contract when the temperature decreases later such that drag may occur in the case of moving the friction member to only the above-mentioned reference distance. Therefore, in consideration of this, the controller 200 may prevent drag by adding an additional distance f to the reference distance e to separate the friction member from the rotating member.

More specifically, referring to FIG. 6, from a brake force request time point a by the driver's brake pedal operation, the controller 200 controls the friction member's clamping force on the rotating member to increase while following the target clamping force, thereby maintaining the target clamping force.

From a time point b at which a brake force release request is input by the driver's brake pedal operation, the controller 200 controls the clamping force to decrease while following the target clamping force, and when the clamping force reaches a predetermined reference clamping force, determines the corresponding time point to be an engagement release time point c at which the friction member is no more in contact with the rotating member.

Additionally, the controller 200 determines the position of the friction member at the engagement release time point to be the reference position d. The controller 200 determines, a distance obtained by taking the reference position d as a zero point, adding a predetermined reference distance e to the reference position d, and further adding an additional distance f to the predetermined reference distance e added to the reference position d, as the distance between the friction member and the rotating member to separate the friction member from the rotating member by the corresponding distance (i.e., the sum of the reference distance e and the additional distance f).

That is, when the estimated temperature of the drum 12 is higher than the predetermined reference temperature as shown in FIG. 5, the controller 200 separates the friction member from the rotating member by a distance equal to the reference position d plus the reference distance e and the additional distance f, when the brake is released, as shown in FIG. 6.

Thereafter, the controller 200 may readjust the position of the friction member over time. In other words, the controller 200 may adjust the position of the friction member so that the distance between the friction member and the rotating member becomes the reference distance e over time. For example, as shown in FIG. 6, the position of the friction member is controlled so that the distance between the friction member and the rotating member is the sum of the reference distance e and the additional distance f, and then the position of the friction member is controlled so that the distance between the friction member and the rotating member becomes the reference distance e.

Meanwhile, when the temperature of the drum 12 may not be estimated, referring to FIG. 7, in order to prevent drag, the controller 200 may separate the friction member from the rotating member by a distance equal to the predetermined reference distance e plus the maximum value of the additional distance f from the reference position d when the brake is released.

FIG. 8 is a flowchart illustrating a brake apparatus control method according to one embodiment of the present disclosure.

Referring to FIG. 8, when a brake force release request is input by the driver's brake pedal operation (300), the controller 200 determines a reference position of the friction member (310) and, when the temperature of the drum 12 may be estimated (320), estimates a temperature of the drum 12 (340). When the temperature of the drum 12 may not be estimated, the controller 200 moves the friction member to a distance equal to the reference position plus the reference distance plus the maximum additional distance from the rotating member (330). When an estimated temperature of the drum 12 is higher than the reference temperature (350), the controller 200 moves the friction member to a distance equal to the reference position plus the reference distance and the additional distance from the rotating member (370), and when the estimated temperature of the drum 12 is lower than the reference temperature (350), the controller 200 moves the friction member to a distance equal to the reference position plus the reference distance from the rotating member (360).

When a brake request is received due to the driver's manipulation or the like while the vehicle is traveling, the controller 200 of the brake apparatus 30 controls the actuator 270 to generate the brake force. When the brake force is generated and then braking release becomes necessary to release the brake due to no breaking request, the controller 200 similarly controls the actuator 270 to release the brake by disengaging the brake lining, which is a friction member, from the drum 12, which is a rotating member.

FIGS. 3 and 4 show a case where the estimated temperature of the rotating member is lower than a predetermined reference temperature. Here, the reference temperature may include two reference temperatures, as shown in FIG. 3, and a case where the estimated temperature is lower than the predetermined reference temperature refers to a case where the estimated temperature of the friction member is lower than the lower temperature of the two reference temperatures at the brake force release time point b.

The controller 200 may estimate a temperature of the rotating member, i.e., the drum 12, from various types of information input via the communication interface 250. The controller 200 may estimate the temperature of the drum 12 from wheel speed information and brake pressure information input through the communication interface 250. For example, when a driver steps on a brake pedal to reduce speed while driving a vehicle, the brake shoes 11a and 11b, to which the brake linings are attached, press the drum 12. When a frictional force occurs due to the drum 12 and the brake lining in contact with each other, the kinetic energy of the vehicle is converted into frictional energy between the drum 12 and the brake lining. The friction energy is converted into heat energy, and some of the heat energy escapes into the air and some of the heat energy are absorbed by the drum 12. Among them, the heat energy absorbed by the drum 12 increases the temperature of the drum 12. Conversely, while the vehicle is traveling or stationary without braking, the heat energy absorbed by the drum 12 escapes to the surrounding connected parts or to the atmosphere in the form of conduction, convection, or radiation, causing the temperature to decrease. Using this conversion process of heat energy, a mathematical model may be created to calculate a temperature of the drum 12. The frictional energy generated by the frictional force is converted into heat energy and absorbed by the drum 12. The heat energy generated by a frictional force may be expressed as a function of the friction coefficient of the brake lining, brake pressure, wheel speed, etc. When the vehicle is traveling or stationary without braking, the heat energy absorbed by the drum 12 is transferred to the surrounding atmosphere or connected parts in the form of conduction, convection, radiation, etc. The total amount of heat energy dissipated from the drum 12 in the form of conduction, convection, and radiation may be calculated by adding all of the respective heat energies. The heat energy dissipated by the vehicle speed may be expressed as a function of wheel speed, air temperature, etc. The final temperature of the drum 12 is determined by a difference between the heat energy absorbed by the drum 12 and the heat energy transferred to the outside during a certain time. From an amount of temperature change due to the difference between the two heat energies, the current temperature of the drum 12 may be obtained. While the vehicle is traveling, the temperature of the drum 12 may be continuously calculated. In addition, the controller 200 may directly detect the temperature of the drum 12 through a temperature sensor that detects the temperature of the drum 12.

When the estimated temperature of the rotating member in the controller 200 is lower than a predetermined reference temperature, the controller 200 may determine a distance between the friction member and the rotating member by adding a predetermined reference distance e to the reference position d, which is the position of the friction member at an engagement release time point c at which the friction member is no more in contact with the rotating member after the brake force release time point b. Here, the reference distance e may have a value ranging from 0.3 mm to 0.8 mm.

More specifically, referring to FIG. 4, from a brake force request time point a by the driver's brake pedal operation, the controller 200 controls the friction member's clamping force on the rotating member to increase while following the target clamping force, thereby maintaining the target clamping force. From a time point b at which a brake force release request is input by the driver's brake pedal operation, the controller 200 controls the clamping force to decrease while following the target clamping force, and when the clamping force reaches a predetermined reference clamping force, determines the corresponding time point to be an engagement release time point c at which the friction member is no more in contact with the rotating member. In addition, the controller 200 determines the position of the friction member at the engagement release time point to be the reference position d. The controller 200 may use this reference position d as a zero point to determine the distance added by the predetermined reference distance e as the distance between the friction member and the rotating member to separate the friction member from the rotating member by the corresponding distance.

That is, as shown in FIG. 3, when the estimated temperature of the drum 12 is lower than the predetermined reference temperature, the controller 200 moves the friction member to a distance equal to the reference position d plus the reference distance e from the rotating member when the brake is released, as shown in FIG. 4.

FIGS. 5 and 6 show a case where an estimated temperature of the drum 12 is higher than a predetermined reference temperature. Here, the reference temperature may include two reference temperatures, as shown in FIG. 5, and a case where the estimated temperature is higher than the predetermined reference temperature refers to a case where the estimated temperature of the friction member is higher than the lower temperature of the two reference temperatures at the brake force release time point b.

When the estimated temperature of the rotating member estimated by the controller 200 is higher than the predetermined reference temperature, the controller 200 may determine the distance between the friction member and the rotating member by adding a predetermined reference distance e to the reference position d, which is the position of the friction member at an engagement release time point c at which the friction member is no more in contact with the rotating member after the brake force release time point b, and further adding an additional distance f thereto. Here, the reference distance e may have a value ranging from 0.3 mm to 0.8 mm. The additional distance f is a value that may be vary depending on the estimated temperature when the estimated temperature is higher than the reference temperature and a value that increases as the estimated temperature is increasingly higher than the reference temperature, as shown in FIG. 7. That is, when the estimated temperature of the drum 12 is higher than the reference temperature at the brake force release time point, the drum 12 may contract when the temperature decreases later such that drag may occur in the case of moving the friction member to only the above-mentioned reference distance. Therefore, in consideration of this, the controller 200 may prevent drag by adding an additional distance f to the reference distance e to separate the friction member from the rotating member.

More specifically, referring to FIG. 6, from the brake force request time point a by the driver's brake pedal operation, the controller 200 controls the friction member's clamping force on the rotating member to increase while following the target clamping force, thereby maintaining the target clamping force. From a time point b at which a brake force release request is input by the driver's brake pedal operation, the controller 200 controls the clamping force to decrease while following the target clamping force, and when the clamping force reaches a predetermined reference clamping force, determines the corresponding time point to be an engagement release time point c at which the friction member is no more in contact with the rotating member. In addition, the controller 200 determines the position of the friction member at the engagement release time point to be the reference position d. The controller 200 determines, a distance obtained by taking the reference position d as a zero point, adding a predetermined reference distance e to the reference position d, and further adding an additional distance f to the predetermined reference distance e added to the reference position d, as the distance between the friction member and the rotating member to separate the friction member from the rotating member by the corresponding distance.

That is, when the estimated temperature of the drum 12 is higher than the predetermined reference temperature as shown in FIG. 5, the controller 200 separates the friction member from the rotating member by a distance equal to the reference position d plus the reference distance and the additional distance d, when the brake is released, as shown in FIG. 6.

Meanwhile, when the temperature of the drum 12 may not be estimated, referring to FIG. 7, in order to prevent drag, the controller 200 may separate the friction member from the rotating member by a distance equal to a predetermined reference distance e plus the maximum value of the additional distance f from the reference position d when the brake is released.

According to one aspect of the present disclosure, the braking stability of the brake apparatus can be secured by preventing the brake apparatus from dragging.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake apparatus, comprising:
a rotating member;
a friction member configured to apply a frictional force to the rotating member during brake engagement;
a motor configured to move the friction member; and
a controller configured to control the motor,
wherein the controller is configured to:
determine a reference position based on a position of the friction member at a time point at which the friction member is no longer in contact with the rotating member upon brake release following the brake engagement, and
control movement of the friction member from the reference position to adjust a distance between the friction member and the rotating member based on a temperature of the rotating member upon the brake release.

2. The brake apparatus of claim 1, further comprising a force sensor configured to detect a clamping force of the friction member.

3. The brake apparatus of claim 2, wherein the controller is configured to determine, based on a current applied to the motor and the clamping force detected by the force sensor, the position of the friction member at the time point at which the friction member is no longer in contact with the rotating member upon the brake release to be the reference position.

4. The brake apparatus of claim 1, wherein the controller is configured to determine, based on a current applied to the motor and position information of the motor, the position of the friction member at the time point at which the friction member is no longer in contact with the rotating member upon the brake release to be the reference position.

5. The brake apparatus of claim 1, wherein the friction member includes a brake lining, and the rotating member includes a drum.

6. The brake apparatus of claim 1, wherein the controller is further configured to move the friction member, away from the rotating member, to a predetermined reference distance from the reference position in response to the temperature of the rotating member being less than or equal to a predetermined reference temperature.

7. The brake apparatus of claim 6, wherein the reference distance ranges from 0.3 mm to 0.8 mm.

8. The brake apparatus of claim 1, wherein, in response to the temperature of the rotating member being higher than a predetermined reference temperature, the controller is configured to move the friction member, away from the rotating member, to a predetermined reference distance plus an additional distance from the reference position, the additional distance determined based on the temperature of the rotating member.

9. The brake apparatus of claim 8, wherein the reference distance ranges from 0.3 mm to 0.8 mm.

10. The brake apparatus of claim 1, wherein the controller is configured to estimate the temperature of the rotating member based on a brake force of the brake apparatus.

11. The brake apparatus of claim 1, wherein, in response to the temperature of the rotating member being not obtainable, the controller is configured to move the friction member, away from the rotating member, to a distance equal to a predetermined reference distance plus a predetermined maximum additional distance from the reference position.

12. A method of controlling a brake apparatus including a rotating member, a friction member configured to apply a frictional force to the rotating member during brake engagement, a motor configured to move the friction member, and a controller configured to control the motor, the method comprising:
determining, by the controller, a reference position based on a position of the friction member at a time point at which the friction member is no longer in contact with the rotating member upon brake release following the brake engagement; and
controlling, by the controller, movement of the friction member from the reference position to adjust a distance between the friction member and the rotating member based on a temperature of the rotating member upon the brake release.

13. The method of claim 12, further comprising detecting a clamping force of the friction member.

14. The method of claim 13, wherein the determining of the reference position includes determining, based on a current applied to the motor and the clamping force of the friction member, the position of the friction member at the time point at which the friction member is no longer in contact with the rotating member upon the brake release to be the reference position.

15. The method of claim 13, wherein the determining of the reference position includes determining, based on a current applied to the motor and position information of the motor, the position of the friction member at the time point at which the friction member is no longer in contact with the rotating member upon the brake release to be the reference position.

16. The method of claim 12, wherein the controlling of the movement of the friction member includes further moving the friction member, away from the rotating member, to a predetermined reference distance from the reference position in response to the temperature of the rotating member being less than or equal to a predetermined reference temperature.

17. The method of claim 12, wherein the controlling of the movement of the friction member includes, in response to the temperature of the rotating member being higher than a predetermined reference temperature, moving the friction member, away from the rotating member, to a distance equal to a predetermined reference distance plus an additional distance from the reference position, the additional distance determined based on the temperature of the rotating member.

18. The method of claim 17, wherein the reference distance ranges from 0.3 mm to 0.8 mm.

19. The method of claim 12, further comprising estimating the temperature of the rotating member based on a brake force of the brake apparatus.

20. The method of claim 12, further comprising moving, in response to the temperature of the rotating member being not obtainable, the friction member, away from the rotating member, to a distance equal to a predetermined reference distance plus a predetermined maximum additional distance from the reference position.

21. The brake apparatus of claim 1, further comprising:
a temperature sensor configured to detect the temperature of the of the rotating member.

22. The brake apparatus of claim 8, wherein
the additional distance is variable depending on the temperature of the rotating member.

23. The brake apparatus of claim 8, wherein
the additional distance is increased as the temperature of the rotating member is increasingly higher than the predetermined reference temperature.

24. The brake apparatus of claim 8, wherein
the additional distance, which is increased as the temperature of the rotating member is increasingly higher than the predetermined reference temperature, has a maximum value, and
in response to the temperature of the rotating member being not obtainable, the controller is configured to move the friction member, away from the rotating member, to a distance equal to a predetermined reference distance plus the maximum value of the additional distance from the reference position.

25. The brake apparatus of claim 24, wherein
the controller is further configured to move the friction member, away from the rotating member, to the predetermined reference distance from the reference position in response to the temperature of the rotating member being less than or equal to the predetermined reference temperature.

26. The brake apparatus of claim 8, wherein
after moving the friction member, away from the rotating member, to the predetermined reference distance plus the additional distance from the reference position,
the controller is configured to control the position of the friction member so that the distance between the friction member and the rotating member becomes the reference distance.

27. The brake apparatus of claim 8, wherein
after moving the friction member, away from the rotating member, to the predetermined reference distance plus the additional distance from the reference position,
the controller is configured to control the position of the friction member so that the distance between the friction member and the rotating member is gradually reduced over time to become the reference distance.
